(19) United States
(12) Patent Application Publication
(10) Pub. No.: US 2024/0077846 A1
(43) Pub. Date: Mar. 7, 2024

(54) Method for Predicting a Service State of a Printing Machine

(71) Applicant: Canon Production Printing Holding B.V., Venlo (NL)

(72) Inventor: Christoph Wüstner, München (DE)

(73) Assignee: Canon Production Printing Holding B.V., Venlo (NL)

(21) Appl. No.: 18/241,415

(22) Filed: Sep. 1, 2023

(30) Foreign Application Priority Data
Sep. 1, 2022 (DE) 10 2022 122 203.9

(51) Int. Cl. G05B 19/4065

(52) U.S. Cl. CPC G05B 19/4065; G05B 2219/37252; G05B 2219/50276

(57) ABSTRACT

A method for predicting a service state of a printing machine at a defined point in time includes:
measuring a plurality of successive process values of a process parameter which is an indicator of the functionality of the printing machine;
determining a plurality of successive scatter values which describe the spread of the measured process values within a predetermined time range;
determining a local scatter minimum of the scatter values;
determining a baseline, in that a baseline value is established that correlates with the value of the process parameter at the point in time of the local minimum and that does not change up until a new determination of a baseline; and
determining a health value at a specific point in time, with a predetermined relation of the process value to the baseline value at this point in time. A service state is assessed
upon the health value exceeding a predetermined threshold.

### CROSS-REFERENCE TO RELATED APPLICATION

This application claims priority to German Patent Application No. 10 2022 122 203.9 filed Sep. 1, 2022, the disclosure of which is hereby incorporated by reference in its entirety.

### BACKGROUND OF THE INVENTION

### Field of the Invention

The present invention relates to a method for predicting a service state of a printing machine.

### Description of Related Art

Given printing machines, especially given high-capacity printing machines, a failure can lead to an enormous economic loss. The entire machine does not necessarily hereby need to fail; it is sufficient if a single element malfunctions, for example the pump for the ink. As of a defined point in time, print jobs thus cannot be printed, or can only be printed poorly. These jobs that are not printed or are poorly printed can to some extent only be determined after the fact. An interruption of the printing process is only possibly with a significant delay. A significant waste of paper, which is also referred to as spoilage, is thus created. In addition, the downtime which arises due to the repair of the failed part—for example the pump—incurs significant production costs.

For a smooth running, it is thus important to know the state of the printing machine, in particular of its individual elements, in order to minimize such failure times.

Traditionally, a printing machine, or the individual parts, is/are serviced at regular intervals. The state of the printing machine is then only detected during the servicing. In the case of doubt, service-prone components are installed without the state of the old component being known at all. This approach leads to frequent downtimes and unnecessary costs, due to an unnecessary replacement.

Given what are known as Predictive Maintenance systems (PdM systems), this problem has been recognized and it is sought to calculate the failure probability of the individual system parts in advance, via diverse sensor systems. The replacement and the preventative measures can hereby be planned before a failure occurs. A user thus profits from an increased availability during the production time.

In existing predictive maintenance systems, however, the values that are output by the sensors do not need to be associated with a failure probability. Often, it is also not possible to provide a uniform association with a product series, since the parameters to some extent depend on many factors that can only in part be associated with a failure probability. The operating temperature is to be cited here as an example. The operating temperature of a machine A at the Arctic Ocean may thus display normal operation at 18° C. and indicate a failure at 25° C., whereas a structurally identical machine at the equator exhibits normal temperature at this 25° C. and only indicates a failure at 30° C.

The detection and setting of the correct parameter values in order to be able to predict a failure only takes multiple operating cycles that must be monitored by a person skilled in the art. This is very time-intensive and can also lead to interruptions, due to a potential lack of availability of a specialist, and is cost-intensive.

### SUMMARY OF THE INVENTION

The invention is based on the object of achieving a method for predicting a service state of a printing machine with which the service state can be reliably predicted in a simple manner.

In a method for predicting a service state of a printing machine at a defined point in time, the following steps are performed:
a) measure a plurality of successive process values of a process parameter which is an indicator of the functionality of the printing machine,
b) determine a plurality of successive scatter values which describe the spread of the measured process values within a predetermined time range,
c) determine a local scatter minimum of the scatter values,
d) determine a baseline, in that a baseline value is established that correlates with the value of the process parameter at the point in time of the local minimum and that does not change up until a new determination of a baseline, and
e) determine a health value at a specific point in time, with a predetermined relation of the process values to the baseline value at this point in time,
wherein, upon the health value exceeding a predetermined threshold, this is assessed as a service state.

The scatter value is a measure of how constant the process values are.

If the process values are constant over a longer period of time, it can be assumed therefrom that this state of the printing machine is desired and a service is not immediately imminent.

Insofar as is not specified otherwise, in the following an extremum, such as a minimum or a maximum, relates to a scatter extremum, or to a scatter minimum or a scatter maximum.

The minimum of the scatter values implies that the process values are constant over a certain time. If the values are not constant, the process values would differ from one another and a scatter value would be greater than given process values that are constant.

The value range where the process values are constant are thus a very good indicator that no service state is present.

This constant range can then be automatically established by the system as a baseline.

It is hereby unnecessary that a person skilled in the art determined the baseline themselves, since this occurs automatically via the method.

Furthermore, an identical method is hereby used for every printing machine. Here, differences that arise, for example due to different methods of the different specialists, or because a specialist to a certain degree sets the baseline arbitrarily according to a “gut feeling,” can create fewer failures that arise due to an incorrect setting of the baseline. Personnel that have had no specialist training in setting baselines are thus also not tempted to define a baseline in spite of a lack of training.

If the state of the printing machine degrades, the process value will also change. It then moves increasingly further away from the baseline value established in advance. The distance from the process value to the baseline value is referred to as a health value, wherein the health value indicates the relation of the process value to the baseline value. The relation indicates the relationship of the process value to the baseline value, wherein here “relationship” is not necessarily to be understood as a quotient, but rather represents a general relation of these two values.

If the health value exceeds a predetermined threshold, the system automatically assesses this as a service state. Here, “exceeds” is to be understood so that the value can also fall below the predetermined threshold. Exceeding is hereby to be understood as crossing or traversing.

Due to the simplicity of the method, it can be used in a plurality of printing machines. It is not limited to a defined type of printing machines.

The physical principal on which the method is based is that the monitored process value of the process parameter changes at a certain time before the printing machine fails, or parts of the printing machine fail. For example, this can result at an operating temperature or due to an altered power consumption.

A failure of the printing machine, or of a part of a printing machine, may arise due to age-related wear, for example, but also due to clogged filters or generally due to fouling, for example. With this method, failure of the printing machine can be predicted independently of the cause.

The advantage of the present method is now that a system which executes the method measures only one process parameter and, using the measured process values, can independently detect whether or not a service state is present, i.e., whether or not the printing machine is healthy. A gauging or calibration by a person skilled in the art who decides whether and when the process value is within a healthy range is not necessary here.

After servicing, a baseline can thus be determined that is different than the original. Transient phenomena and also changes to components that influence the characteristic of the system (for example new motor, or exchanging a consumable part) can be taken into account via the method described here.

Preferably, a local scatter maximum control value is determined before the determination of the local scatter minimum (step c), wherein, if no maximum has been detected, the earliest point in time in the scatter values is established as a maximum, and the scatter minimum to be determined comes chronologically after the maximum.

That the scatter minimum to be determined comes chronologically after the maximum is to be understood here such that it is used only for the method with steps A through E. If the method is repeatedly executed serially, a scatter minimum can naturally be present before a scatter maximum.

A scatter maximum is present when process values change very starkly in a short time period. For example, this can occur due to a service in which a component of the printing machine is exchanged, such that subsequently, directly after the servicing, the printing machine outputs different process values than it did directly before the servicing. Such a discontinuity that arises due to the servicing generates a scatter maximum.

A scatter maximum can thus be an indicator of a servicing. If a scatter maximum has been detected, the corresponding method should start in order to detect a scatter minimum, to detect a baseline, and to calculate health values in order to be able to predict a new service state.

If the method is initially applied, it may be that there has previously been no maximum. Thus, the start point in time is then to be established as a maximum.

The relationship of the process values to the baseline value to determine the health value is provided by:
the difference of the two values,
by a nonlinear function, or
by association from a previously stored table.

The difference indicates the simplest instance. The health value then correlates to the process value, such that a change of, for example, from 10 to 20% has an identical difference as a change between 80 and 90%.

A nonlinear function can, for example, be provided by a logarithmic or exponential function. A change of the health value from 20 to 10% hereby reflects a different difference of change than given a change from 90 to 80%.

This may be reasonable if, for example, the printing machine is not in a service state within a narrow range of process values, but a change out of this narrow range can rapidly induce a service state. This range of the service state can then be very large, until a total failure of the printing machine occurs.

In order to be able to represent these different ranges, the association or the relationship must be nonlinear.

The association can also take place via a previously stored table. The corresponding values of the baseline and of different process values are stored in the table, and a health value can be read from this table.

Furthermore, it is conceivable to thus also represent diverse functions. In principle, for example, it is also possible that there are various ranges in which process parameters do not indicate a service state, and instead other ranges which lie in-between imply a service state.

According to one embodiment, the scatter parameter is the standard deviation.

The standard deviation is a typical parameter for determining the scattering and is already integrated into many programs and systems, such that a realization of the method here requires no additional programming.

It is also conceivable to use other scatter parameters, for example the variance.

The process values are preferably smoothed according to an EWMA (exponentially weighted moving average) algorithm.

Given such an exponentially weighted smoothed average value, more recent data points are more strongly weighted than those further in the past, meaning that, the further that the values lie in the past, the less their influence.

This leads to the situation that, on the one hand, the output of the curves is smoothed, but variations that might initiate a service state are not smoothed out by the averaging. Nevertheless, indicators of service states are presented promptly in this method.

The typical half-life period of the smoothing should preferably amount to eight cycles. Although the curve is smoother given a higher number, the reaction to individual outliers is slower, and possible individually occurring extremes in the process values might be too strongly smoothed.

The averaging should be adjusted such that a good balance is set between smoothing and sufficient sharpness of the process values.

The determined range preferably represents the most recent values in comparison to the determined point in time, preferably the most recent 10,000 values, preferably the most recent 1,000 values, preferably the most recent 100 values, and especially preferably the most recent 10 values.

The number required for the method also depends on how often measurement takes place. For example, if measurement takes place only three times per day and the range should comprise 100 values, the duration of the range is 33 days. This may be too long, under the circumstances. However, on the other hand, if one value is recorded per minute, the duration of the range is just 1 hour 20 minutes [100 minutes=1 hour 40 minutes], which under the circumstances is too short.

The window size should be selected so as to completely record significant rises or falls. The scatter parameter can thus most effectively determine the extrema (maximum and minimum).

If the duration is too long, it may be that the curve of the process parameter reacts too slowly to changes.

If a plurality of minima has been detected, a minimum is preferably set in that the chronologically oldest minimum is chosen, or in that the minimum is chosen at which the process value corresponding thereto indicates a healthier machine.

A healthy machine in the sense of the present invention is a printing machine whose health value is near optimum. The healthier a printing machine, the closer the health value to the optimum. The unhealthier a printing machine, the more a service state is present, and the more that the machine threatens to fail.

If the chronologically oldest minimum is chosen, a service state can be detected early.

If a minimum is chosen at which the process value corresponding thereto indicates a healthier machine, the baseline for the process parameter is chosen accordingly close to the optimal value for the machine.

According to one embodiment, the minimum may be below a defined threshold, wherein this threshold—insofar as the scatter parameter corresponds to the standard deviation—preferably corresponds to a standard deviation of 10, preferably a standard deviation of 5, and in particular a standard deviation of 2.

By establishing the threshold, it is ensured that an incorrect minimum is not chosen. For example, an incorrect minimum may lead to a wrong baseline value being selected, and the health value thereby being falsely or insufficiently calculated.

In experiments, a standard deviation of 10, preferably a standard deviation of 5, and especially a standard deviation of 2 has resulted in a sufficient threshold for determining the minimum. The health value is preferably normalized via multiplication with a predefined scaling factor, wherein the health value at 100 specifies a normally functioning printing machine, and a lower value indicates a pending service outage of the printing machine.

Given a different lower value, a service outage can itself be present.

The health value can also be normalized to other values, for example 1,000, 10,000, 1,000,000, or 10, or 1.

Should it not be possible to specify absolute values for the minimum or for the maximum, 1% of the expected baseline has been proven as a starting point for the maxima threshold. 0.5 to 1% of the expected baseline has been proven as a starting point for the minimum threshold.

According to one development, the method can have different service states with different predetermined thresholds.

Here the different service states can be associated with different hazard levels or probabilities of a failure of the printing machine or of a part of the printing machine.

For example, it is thus conceivable that a first service state is present and a first warning is output at a first predetermined threshold whose critical time window is, however, in the range of weeks if not months.

Given a further degradation of the printing system, a second service state may be present that outputs a more urgent warning. Here, the printing machine should be serviced promptly. Given an even further degradation of the system, a third service state may be present that indicates that a failure of the printing machine or of a part of the printing machine is immediately pending or has already occurred.

### BRIEF DESCRIPTION OF THE DRAWINGS

The terms Fig., Figs., Figure, and Figures are used interchangeably in the specification to refer to the corresponding figures in the drawings.

The invention is explained in detail in the following by way of example, using the examples depicted in the drawings.

The drawings schematically show:

FIG. 1 a printing system with connected evaluation unit, as a block diagram,

FIG. 2a-c time curve of the process parameter (a), of the scatter value (b), and of the health value (c), in corresponding diagrams, and

FIG. 3 a method for predicting a service state of a printing machine, as a flow diagram.

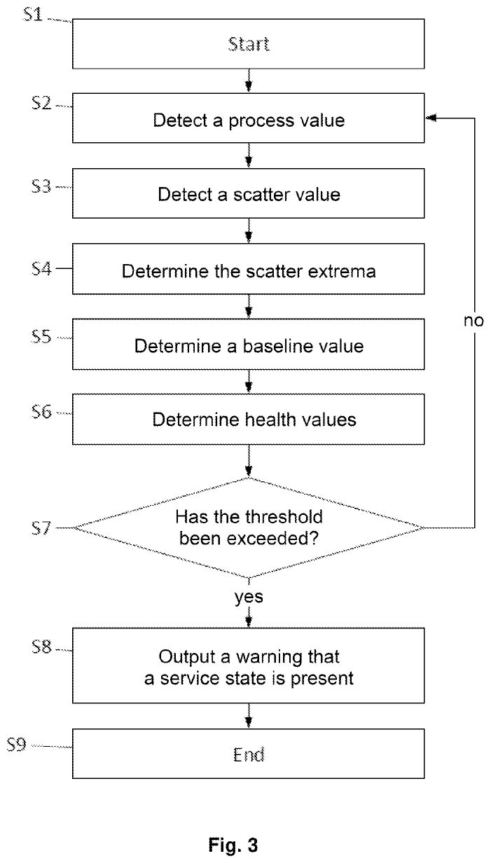

### DESCRIPTION OF THE INVENTION

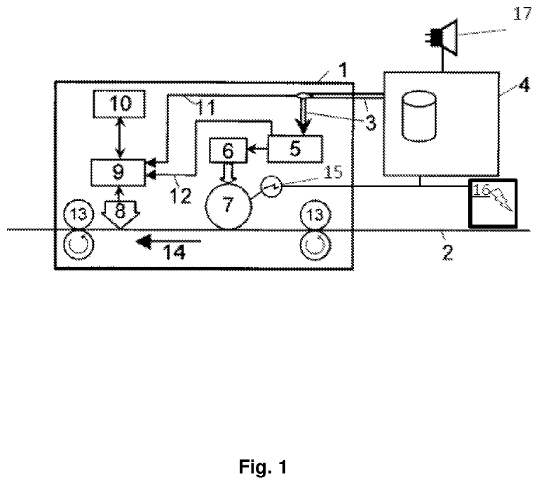

An exemplary embodiment for executing a method for predicting a service state of a printing machine 1 at a defined point in time, in the form of a printing system, is explained in the following (FIG. 1).

This printing system comprises a printing machine for printing to a recording medium 2.

The recording medium 2 is typically a continuous web. However, the conveying device can also be designed to convey individual sheets along the conveying route.

The recording medium 2 is typically paper. The paper may have the most diverse qualities. However, the recording medium can also be a plastic film or a paper coated with plastic. In the following, it is also called a paper web 2.

In this exemplary embodiment, the printing machine 1 is a high-capacity printing machine. What is understood as high-capacity printing within the sense of the present invention is the use of a printing apparatus that can print to at least 5 pages of DIN A4 size per second. Printing apparatuses for high-capacity printing can, however, also be designed for higher printing speeds such as, for example, at least 30 pages of DIN A4 size per second, and in particular at least 50 pages of DIN A4 size per second, and preferably at least 90 pages of DIN A4 size per second. Such a printing apparatus is typically designed as an inkjet printing apparatus or as an electrophotographic printing apparatus. It may also be a printing apparatus whose printing ink is liquid toner.

The printing machine 1 in this exemplary embodiment is an inkjet printing apparatus.

The printing machine 1 is connected via a data line 3 with a computer or print server 4 from which the printing machine 1 receives a print data stream via the data line 3. The computer 4 is either a print server that caches or relays the print data stream and executes certain pre-processing steps, or a host at which the print job and the corresponding print data stream are generated. The IPDS (Intelligent Printer Data Stream) print data stream, which is typical for high-capacity printers, is used as a print data stream. Of course, it is also possible to use print data streams in other formats such as, for example, PCL (Print Command Language), PS (PostScript), or AFP (Advanced Function Presentation).

In the printing machine 1, the data line 3 leads to a controller 5 in which the print data contained in the print data stream are prepared for a subsequently arranged character generator. A character generator 6 generates control signals to drive a print head 7 with which the print data are printed onto the paper web 2.

The controller 5 is furthermore connected with a device controller (not shown) that drives the various units of the printing apparatus, for example the paper transport, the electrophotography unit, the fixing station etc. Furthermore, the controller 5 is connected with a control panel at which system information can be displayed and via which adjustments to the printing machine 1 can be made. It can comprise known means such as a monitor (in particular a touchscreen), keyboard, and/or mouse etc.

For high-capacity printers, the paper web 2 is typically a continuous web. However, by now printing machines with very high capacity are also known that print to individual sheets, given which the application of the method according to the invention is also appropriate.

Checksums are generated in the controller 5 and inserted into the print data stream. This is explained in detail below.

Downstream of the print head 7, a sampling sensor 8 for sampling the checksums printed onto the paper web 2 is provided adjoining the paper web 2. If the checksums are printed in the form of a barcode, the sensor is a simple photosensor that detects the brightness differences on the paper web. The sampling sensor 8 is connected with a monitoring device 9 that in turn is coupled to a central print controller 10.

The paper web 2 is driven in the conveying direction 14 by a conveying device 13.

The data stream delivered via data line 3 contains additional information about the print job, for example sheet or page numbers, that are also delivered via a further data line 11 to a monitoring device 9. As an alternative to this, additional information can initially be delivered only to the controller 5, which then forwards these to the monitoring device 9 via a further data line 12. The data line 11 can then be omitted. In this instance, it is also possible that the controller 5 itself generates the additional information about the print job and delivers said information to the monitoring device 9 in the event that the computer 4 provides no such information.

The printing machine 1 has still more units that are known per se, for example a heating station for drying the printed recording medium. These additional units are not necessary to explain the present invention, which is why they are not depicted in the drawings and are not explained in detail in the specification.

The printing machine 1 furthermore comprises a sensor 15 for measuring process values 16 of a process parameter which is an indicator of the functionality of the printing machine 1. The sensor 15 is connected with the computer 4 via a data line. The data line can be identical to the data line 11. The data can be transmitted from the sensor 15 to the computer 4 via a cable, for example a LAN cable; however, it is also possible that the process values 16 are transmitted wirelessly, for example via WiFi, Bluetooth, Zigbee, Z-Wave, or NFC.

In this instance, the process parameter is the rotation speed of a pump motor for driving a pump to pump ink to the print head 7 of the printing machine 1.

The slower that the pump rotates, the more probable it is that the pump is clogged and must be serviced.

Alternatively, the power consumption of the pump motor for ink of the printing machine 1 can also be monitored.

The more current that the pump requires, the more energy that the pump consumes. Given a consistent ink flow, this is an indicator of the health status of the pump. The more current that the pump requires, the more probable that it is that the pump itself is clogged and must be serviced.

The physical principle on which the method is based is that the efficiency of the pump changes at a certain time before the pump fails. A few days before the pump fails, the pump will pump somewhat less strongly than before given the same electrical power.

A failure of the pump can arise due to, for example, age-related wear, but also due to clogged filters.

Other alternatives may comprise sensors 15 that implement one or more of the following monitorings:
shrinkage monitoring,
lubricant and wear particle analysis,
bearing and temperature analysis,
performance monitoring,
ultrasonic noise detection,
ultrasonic flow,
infrared thermography, and
visual inspection.

The process values 16 which are measured by the sensor 15 are sent to the computer 4, which is designed to analyze the process values as is described in the method for predicting a service state. The computer 4 can also establish whether an unhealthy state is present and generate a warning signal that, for example, is output acoustically via a loudspeaker, or to a display device in the form of a graphic and/or text.

The process values 16 are pre-processed at the computer 4 via an exponentially weighted, smoothed average.

Here, for example, the process values are measured three times per day, meaning that there is a time interval of 8 hours between the measured values.

The computer 4 is linked with a warning output 17. The warning output 17 informs a user if a service state has been detected by the computer 4. In this exemplary embodiment, the warning output 17 is a notification device that sends an e-mail to a provided user.

The method for predicting a service state of a printing machine at a defined point in time is explained in the following.

The method begins with step S1 (FIG. 1).

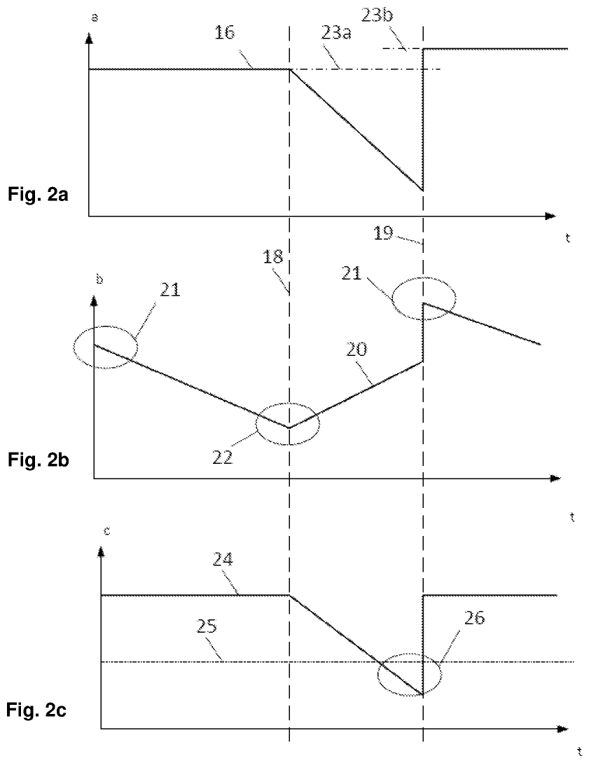

In the next step (S2), the process value 16 is detected by the sensor 15 (FIG. 2). Since, in this exemplary embodiment, the process value 16 is the rotational speed of the pump, which is determined indirectly via the current to be recorded.

In this exemplary embodiment, the time interval between two measurement recordings is eight hours.

The determined process values 16, together with a time stamp, are recorded by the computer 4.

The pump rotation typically remains constant, unless a clogging of the pump occurs, as of which point in time the health of the pump decreases little by little. Such a slow wear is detectable by a decrease in the rotation speed, which is represented at point in time 18 in FIG. 2. An exchanging of a pump, thus a servicing, occurs at point in time 19.

In step S3, a scatter value 20 is determined which describes the scattering of the measured process values 16 within a predetermined time range. In this exemplary embodiment, the scatter value 20 is the standard deviation of the EBMA-smoothed process values 16. The standard deviation of the last 100 values (i.e. of the last 33 days) is hereby selected.

Step S4 follows, in which the scatter extrema are determined.

A scatter maximum is hereby identified first. A scatter maximum 21 arises when the process values 16 change strongly within a short time, or when a method begins entirely anew. In FIG. 2, two scatter maxima 21 are thus to be detected, the one to be detected at the beginning of the method, on the left side, the second after an exchanging of the pump.

Only one maximum and one minimum are sought during a method pass. Multiple maxima or minima are not sought.

If a plurality of scatter maxima 21 are present, the most chronologically recent scatter maximum 21 is selected. If no scatter maximum 21 is detected in the curve, the chronological zero point—thus the start of the method—is established as a maximum.

A scatter minimum 22 is located chronologically after a scatter maximum 21. This leads to the situation that the scatter maximum 22 acts as a type of zeroing of the method. Values before a maximum are thus not considered.

The point in time of a scatter minimum 22 corresponds to a point in time at which the process values 16 are stable over a certain duration. The more stable the process values 16, the fewer outliers there are in the process values 16, and the smaller the scatter value 20, and therewith the more pronounced the minimum of the scatter value 22.

Stable process values characterize a healthy machine, i.e., the process value 16 is at an optimum and a service state is not to be expected.

In the following step (S5), a baseline 23a, 23b is determined in that a baseline value is established that correlates with the value of the process parameter 16 at the point in time of the local minimum 22 and that does not change up to a new determination of a baseline 23a, 23b.

In the present exemplary embodiment, the correlation takes place in that the value of the process value at the point in time of the minimum 22 is chosen as a baseline value. However, other correlations are also possible which are normally a function of the process value at the point in time of the minimum 22.

Afterward, a health value 24 is determined in step S6. In this exemplary embodiment, the health value is the difference of the process value 16 from the baseline value 23a, multiplied by a scalar normalization factor that sets the health value to 100% if the process value 16 and the baseline value 23a coincide. 0% then corresponds to a predetermined deviation of process value 16 and the baseline value 23a. In principle, the deviation—which can be normalized or weighted—from the baseline is determined with the health value, and the stronger the deviation, the poorer the “health” and the more probable a service state.

In the subsequent step S7, it is queried whether a threshold 25 has been exceeded. This threshold has been established in advance and, in this exemplary embodiment, is at n sigma, wherein n is preferably 1; 1.5; 2; 2.5; or 3. Two sigma correspond to 13.6%. In FIG. 2, the threshold is exceeded in the last third of the time period between the health decline and the exchanging of the pump.

If no exceeding of the threshold 25 is established, a process value is re-detected (step S2).

However, if an exceeding of the threshold 25 is established, this is assessed as a service state 26, and in the following step S8 a warning is output that a service state 26 is present.

The method ends with step S9.

In other exemplary embodiments, the warning output 6 can also be designed as an acoustic signal transmitter, or as a lamp that lights as soon as a service state is present. A combination is possible here.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For the purposes of this discussion, the terms “controller” or “control device” shall be understood to be circuit(s) or processor(s), or a combination thereof, including memory storing instructions. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor.

1. A method for predicting a service state of a printing machine at a defined point in time, the method comprising:
a) measuring a plurality of successive process values of a process parameter which is an indicator of a functionality of the printing machine;
b) determining a plurality of successive scatter values which describe a spread of the measured process values within a predetermined time range;
c) determining a local scatter minimum of the scatter values;
d) determining a baseline, in that a baseline value is established that correlates with a value of the process parameter at a point in time of the local scatter minimum and that does not change up until a new determination of the baseline, and
e) determining a health value at a specific point in time, with a predetermined relation of the process value to the baseline value at the specific point in time,
wherein, a service state is assessed upon the health value exceeding a predetermined threshold.

2. The method according to claim 1,
wherein
a local scatter maximum of the scatter values is determined before the determination of the local scatter minimum, wherein, if no maximum has been detected, an earliest point in time in the scatter values is set as a maximum,
and in that the local scatter minimum to be determined comes chronologically after the maximum.

3. The method according to claim 1,
wherein
a relationship of the process values to the baseline value for determining the health value is provided by:
the difference of the two values,
by a nonlinear function, or
by association from a previously stored table.

4. The method according to claim 1,
wherein
a scatter parameter is the standard deviation.

5. The method according to claim 1,
wherein
the process values are EWMA (exponentially weighted moving average)-smoothed.

6. The method according to claim 1,
wherein
the determined range represents the most recent values in comparison to the determined point in time.

7. The method according to claim 1,
wherein
if a plurality of minima has been detected, a minimum is set
in that the chronologically oldest minimum is chosen, or
in that the minimum is chosen at which the process value corresponding thereto indicates a healthier machine.

8. The method according to claim 4,
wherein
if no minima have been detected, the point in time of the least value of the scatter parameter is selected.

9. The method according to claim 8,
wherein
the minimum must be below a defined threshold.

10. The method according to claim 1,
wherein
the health value is normalized by multiplication with a predefined scaling factor, whereby the health value at 100 indicates a normally functioning printing machine, and a lower value indicates an imminent service failure of the printing machine.

11. The method according to claim 1,
wherein
the method has different service states with different predetermined thresholds.

12. A printing machine with a control device for predicting a service state, wherein the control device is designed to execute the method according to claim 1.

13. The printing machine according to claim 12,
wherein
a local scatter maximum of the scatter values is determined before the determination of the local scatter minimum, wherein, if no maximum has been detected, an earliest point in time in the scatter values is set as a maximum,
and in that the local scatter minimum to be determined comes chronologically after the maximum.

14. The printing machine according to claim 12,
wherein
a relationship of the process values to the baseline value for determining the health value is provided by:
the difference of the two values,
by a nonlinear function, or
by association from a previously stored table.

15. The printing machine according to claim 12,
wherein
a scatter parameter is the standard deviation.

16. The printing machine according to claim 12,
wherein
the process values are EWMA (exponentially weighted moving average)-smoothed.

17. The printing machine according to claim 12,
wherein
the determined range represents the most recent values in comparison to the determined point in time.

18. The printing machine according to claim 12,
wherein
if a plurality of minima has been detected, a minimum is set
in that the chronologically oldest minimum is chosen, or
in that the minimum is chosen at which the process value corresponding thereto indicates a healthier machine.

19. The printing machine according to claim 15,
wherein
if no minima have been detected, the point in time of the least value of the scatter parameter is selected.

20. The printing machine according to claim 12,
wherein
the health value is normalized by multiplication with a predefined scaling factor, whereby the health value at 100 indicates a normally functioning printing machine, and a lower value indicates an imminent service failure of the printing machine.
